(19) United States
(12) Patent Application Publication
(10) Pub. No.: US 2026/0161216 A1
(43) Pub. Date: Jun. 11, 2026

(54) DYNAMIC VOLTAGE AND FREQUENCY SCALING FOR HETEROGENEOUS PROCESSOR CORE GROUP ARCHITECTURE

(71) Applicant: QUALCOMM Incorporated, San Diego, CA (US)

(72) Inventors: Hoan Huu NGUYEN, Cary, NC (US); Mohd Imran BEG, Whitby (CA); Nitin MAKHIJA, San Jose, CA (US); Sneha WANI, Bellevue, WA (US)

(21) Appl. No.: 18/971,649

(22) Filed: Dec. 6, 2024

(51) Int. Cl. G06F 1/3296; G06F 1/3234; G06F 1/324

(52) U.S. Cl. CPC G06F 1/3296; G06F 1/324; G06F 1/3275

(57) ABSTRACT

Aspects of the disclosure are directed to providing dynamic voltage and frequency scaling (DVFS) capability. In accordance with one aspect, the disclosure includes determining a cross core group operational framework; determining which of a first plurality of processor cores, a second plurality of processor cores and a third plurality of processor cores of the cross core group operational framework is active to generate a determination; and adjusting a first supply voltage and a first clock frequency depending on the determination. In one example, a first processor core group includes the first plurality of processor cores and an auxiliary group, wherein a second processor core group includes the second plurality of processor cores, and wherein a third processor core group includes the third plurality of processor cores.

### TECHNICAL FIELD

This disclosure relates generally to the field of information processing systems, and, in particular, to a dynamic voltage and frequency scaling technique for a heterogeneous processor core group architecture.

### BACKGROUND

An information processing system with a plurality of processor core groups may have a heterogeneous architecture with diverse supply voltage and frequency requirements. An efficient power management technique is desired for a heterogeneous processor core group architecture using dynamic voltage and frequency scaling (DVFS).

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides dynamic voltage and frequency scaling (DVFS) capability. Accordingly, the present disclosure discloses an apparatus including: a first processor core group, wherein the first processor core group includes a first plurality of processor cores, a first power state machine and an auxiliary group; a second processor core group coupled to the first processor group, wherein the second processor core group includes a second plurality of processor cores; a third processor core group coupled to the second processor group, wherein the third processor core group includes a third plurality of processor cores, wherein the first power state machine is configured to determine which of the first plurality of processor cores, the second plurality of processor cores and the third plurality of processor cores is active to generate a determination; and a first dynamic voltage and frequency scaling (DVFS) module, coupled to the first power state machine, the first DVFS module configured to adjust a first supply voltage and a first clock frequency of the first processor core group based on the determination.

Another aspect of the disclosure provides an apparatus including: means for determining a cross core group operational framework; means for determining which of a first plurality of processor cores, a second plurality of processor cores and a third plurality of processor cores of the cross core group operational framework is active to generate a determination; and means for adjusting a first supply voltage and a first clock frequency depending on the determination.

Another aspect of the disclosure provides a method including: determining a cross core group operational framework; determining which of a first plurality of processor cores, a second plurality of processor cores and a third plurality of processor cores of the cross core group operational framework is active to generate a determination; and adjusting a first supply voltage and a first clock frequency depending on the determination.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example heterogeneous processor core group architecture.

FIG. 3 illustrates a first example supply voltage and clock frequency curve.

FIG. 4 illustrates a second example supply voltage and clock frequency curve.

FIG. 5 illustrates an example cross core group dynamic voltage and frequency scaling (DVFS) architecture.

FIG. 6 illustrates an example flow diagram 600 for implementing dynamic voltage and frequency scaling (DVFS) capability.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

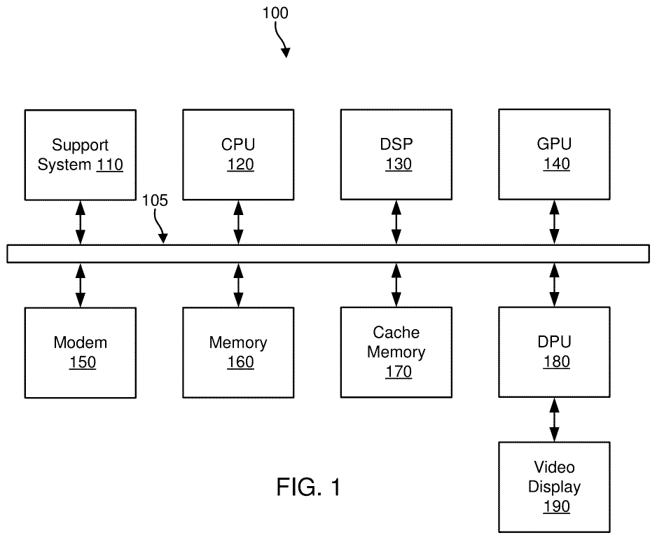

FIG. 1 illustrates an example information processing system 100. In one example, the information processing system 100 includes a plurality of processing engines, or processor cores, such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. For example, the memory 160 and/or the cache memory 170 may be shared among the CPU 120, the GPU 140 and the other processing engines. In one example, any processing engine of the plurality of processing engines may have an internal memory (i.e., a dedicated memory) which is not shared with the other processing engines.

An information processing system may be a heterogeneous processor core group architecture where each processor core group includes a plurality of processor cores of the same type. Moreover, each processor core group may include a dedicated power management and logic control module to set a supply voltage (Vs) and a clock frequency (fc) to specific values.

In one example, the dc power consumption for each processor core may be determined from

Pdc=k Vs²fc
where Pdc=dc power consumption, watts
k=device-dependent scaling factor, watts/volts² Hz
Vs=supply voltage, volts
fc=clock frequency, Hz.

In one example, dc power consumption may be minimized by reducing the supply voltage Vs and the clock frequency fc to smaller values. However, core processor performance generally improves by increasing the supply voltage Vs and the clock frequency fc to larger values. Thus, there are conflicting design drivers for setting the supply voltage Vs and the clock frequency fc to specific values.

In one example, the heterogeneous processor core group architecture includes a plurality of processor core groups, where each processor core group includes a plurality of processor cores of the same type and has a dedicated power management and logic control module. In one example, the dedicated power management and logic control module is also known as a power state machine (PSM). In one example, the PSM is an idle power state machine (i.e., digital sequential logic) which manages system on/off state transitions.

In one example, the plurality of processor core groups includes a first processor core group, a second processor core group and a third processor core group. In one example, the first processor core group is a large high performance core group (i.e., an L-Core Group). In one example, the second processor core group is a medium performance core group (i.e., an M-Core Group). In one example, the third processor core group is a medium performance, low power core group (i.e., an MLP-Core Group). In one example, each processor core group of the plurality of processor core groups has a dedicated power state machine (PSM).

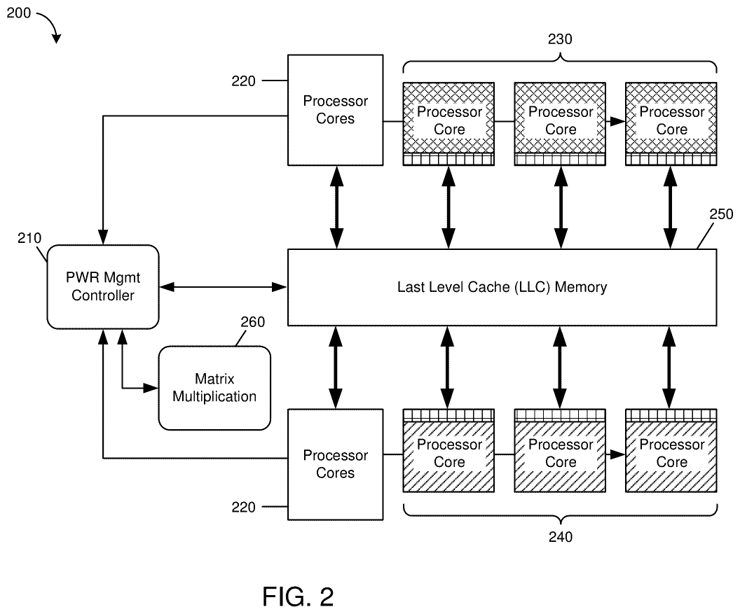

FIG. 2 illustrates an example heterogeneous processor core group architecture 200. In one example, the heterogeneous processor core group architecture 200 includes a power management controller 210, a first plurality of processor cores 220, a second plurality of processor cores 230, a third plurality of processor cores 240, a last level cache (LLC) memory 250 and a matrix multiplication module 260. In one example, the first plurality of processor cores 220 is a large high performance core group (e.g., an L-Core Group). In one example, the second plurality of processor cores 230 is a medium performance core group (e.g., an M-Core Group). In one example, the third plurality of processor cores 240 is a medium performance, low power core group (e.g., an MLP-Core Group). In one example, the LLC memory 250 is a shared cache memory for the first plurality of processor cores 220, the second plurality of processor cores 230 and the third plurality of processor cores 240. In one example, the matrix multiplication module 260 is a processor core which is optimized for high dimensionality mathematical operations (e.g., matrix multiplication).

In one example, separate dedicated power state machines for each of the first plurality of processor cores 220, the second plurality of processor cores 230 and the third plurality of processor cores 240 are used for independent supply voltage and clock frequency control. In one example, the matrix multiplication module 260 may share a power state machine with the first plurality of processor cores 220. For example, the matrix multiplication module 260 may operate with a same supply voltage as the supply voltage used for the first plurality of processor cores 220 and may operate with a different clock frequency from the clock frequency used for the first plurality of processor cores 220.

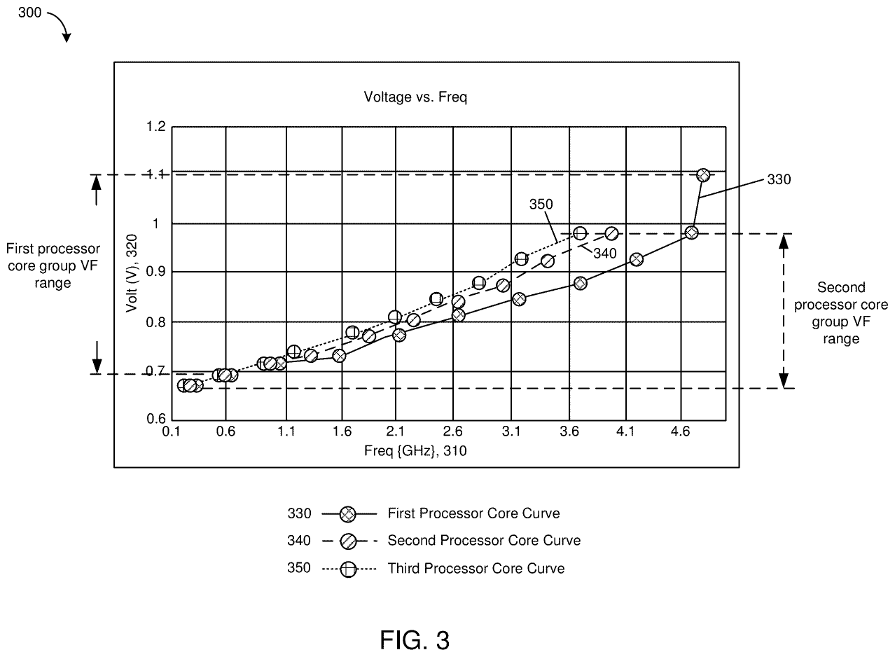

FIG. 3 illustrates a first example supply voltage and clock frequency curve 300. In one example, the first example supply voltage and clock frequency curve 300 includes a clock frequency axis 310, a supply voltage axis 320, a first processor core curve 330, a second processor core curve 340 and a third processor core curve 350. In one example, the clock frequency axis 310 has units of gigahertz (GHz) and the supply voltage axis 320 has units of volts (V). In one example, the first processor core curve 330 corresponds to a first processor core group (e.g., a large high performance L-core group), the second processor core curve 340 corresponds to a second processor core group (e.g., a medium performance M-core group) and the third processor core curve 350 corresponds to a third processor core group (e.g., a medium performance, low power MLP-core group).

In one example, the first processor core curve 330 shows that the first processor core group operates with the highest supply voltage and highest clock frequency. In one example, the third processor core curve 350 shows that the third processor core group operates with optimized power efficiency. For example, a shared LLC module and a matrix multiplication module operate with a first power state machine (PSM) of the first processor core group with a higher supply voltage and clock frequency than for the second processor core group and the third processor core group.

In one example, each processor core group has an independent dynamic voltage and frequency scaling (DVFS) capability with a dedicated power state machine which may be tuned for a specific workload. For example, FIG. 3 illustrates that the shared LLC module and the matrix multiplication module are operated at a supply voltage and clock frequency which are optimized for high performance, rather than for dc power efficiency.

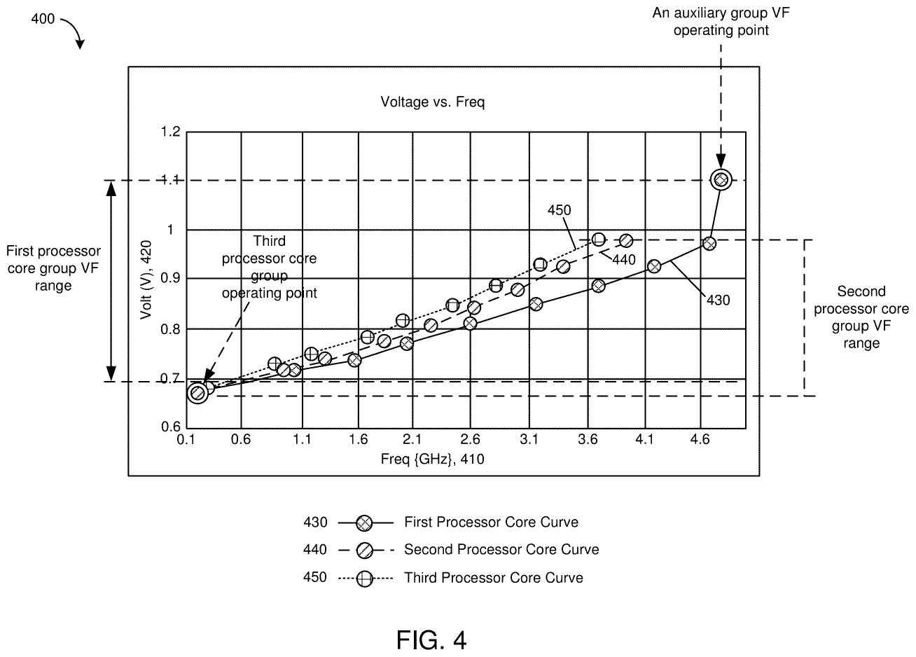

FIG. 4 illustrates a second example supply voltage and clock frequency curve 400. In one example, the second example supply voltage and clock frequency curve 400 highlights operating point differences between an auxiliary group and the other processor core groups along the second example supply voltage and clock frequency curve 400. In one example, the second example supply voltage and clock frequency curve 400 particularly points out an operating point of the auxiliary group and an operating point of the third processor core group. In one example, the second example supply voltage and clock frequency curve 400 includes a clock frequency axis 410, a supply voltage axis 420, a first processor core curve 430, a second processor core curve 440 and a third processor core curve 450. In one example, the clock frequency axis 410 has units of gigahertz (GHz) and the supply voltage axis 420 has units of volts (V). In one example, the first processor core curve 430 corresponds to a first processor core group (e.g., a large high performance L-core group), the second processor core curve 440 corresponds to a second processor core group (e.g., a medium performance M-core group) and the third processor core curve 450 corresponds to a third processor core group (e.g., a medium performance, low power MLP-core group).

In one example, a cross core group operational framework is first determined. For example, the cross core group operational framework describes a multiprocessor operational configuration where a plurality of processor core groups are subject to dc power management. In one example, the cross core group operational framework may have an auxiliary group (e.g., shared LLC module and a matrix multiplication module) operating with a dedicated power state machine (PSM) of the first processor core group with a higher supply voltage and clock frequency than for the second processor core group and the third processor core group.

In one example, the cross core group operational framework may have the first processor core group and the second processor core group inactive (i.e., in an off power state), and the third processor core group active (i.e., in an on power state) with a supply voltage and clock frequency much lower than a minimum supply voltage and clock frequency of the first processor core group. In one example, the auxiliary group (e.g., shared LLC module and matrix multiplication module) operates with a higher supply voltage and higher clock frequency than required by the third processor core group. As a result, a significant amount of wasted dc power consumption is illustrated in FIG. 4 when the auxiliary group operates with the supply voltage and clock frequency of the first processor core group.

In one example, within a heterogeneous processor core group system, a plurality of processor cores may be instantiated (i.e., implemented). For example, a first plurality of processor cores is a large high performance core group (e.g., an L-Core Group). For example, a second plurality of processor cores is a medium performance core group (e.g., an M-Core Group). For example, a third processor core group is a medium performance, low power core group (e.g., an MLP-Core Group).

In one example, the first plurality of processor cores may be optimized for peak performance and may be active for short burst time intervals and put into a sleep mode periodically. In one example, the second plurality of processor cores and the third plurality of processor cores may be optimized for sustained performance with a higher duty cycle than the first plurality of processor cores.

In one example, improved power efficiency for an auxiliary group (e.g., a shared LLC module and matrix multiplication module) which operates in a first power state (pstate) may be attained. In one example, the first power state is a combination of a first supply voltage and a first clock frequency associated with the first plurality of processor cores. For example, improved power dc power efficiency may be attained with the following two design choices.

In one example, a first design choice extends a range of supply voltage and clock frequency for the auxiliary group over a full operational range. For example, the full operational range includes a highest power state (pstate) set to a maximum power state of the first plurality of processor cores. For example, the full operational range includes a lowest power state (pstate) set to a minimum power state of the third plurality of processor cores.

For example, a second design choice implements a cross core group (CG) dynamic voltage and frequency scaling (DVFS) capability. In one example, the first plurality of processor cores hosts a first DVFS implementation which controls the supply voltage and clock frequency for the auxiliary group (e.g., shared LLC module and matrix multiplication module). In one example, a second DVFS implementation for the shared LLC module and matrix multiplication module is hosted by either the second plurality of processor cores or the third plurality of processor cores.

In one example, for the second DVFS implementation, if the first plurality of processor cores is power collapsed (i.e., in an inactive state), then the second plurality of processor cores hosts a cross core group DVFS capability for the auxiliary group (e.g., shared LLC module and matrix multiplication module). In one example, for the second DVFS implementation, if the first plurality and second plurality of processor cores are power collapsed (i.e., in an inactive state), then the third plurality of processor cores hosts a cross core group DVFS capability for the auxiliary group (e.g., shared LLC module and matrix multiplication module).

In one example, the cross core group DVFS capability may be implemented by augmenting a DVFS microarchitecture logic flow to allow a cross core group DVFS power state change request when the first plurality of processor cores is power collapsed.

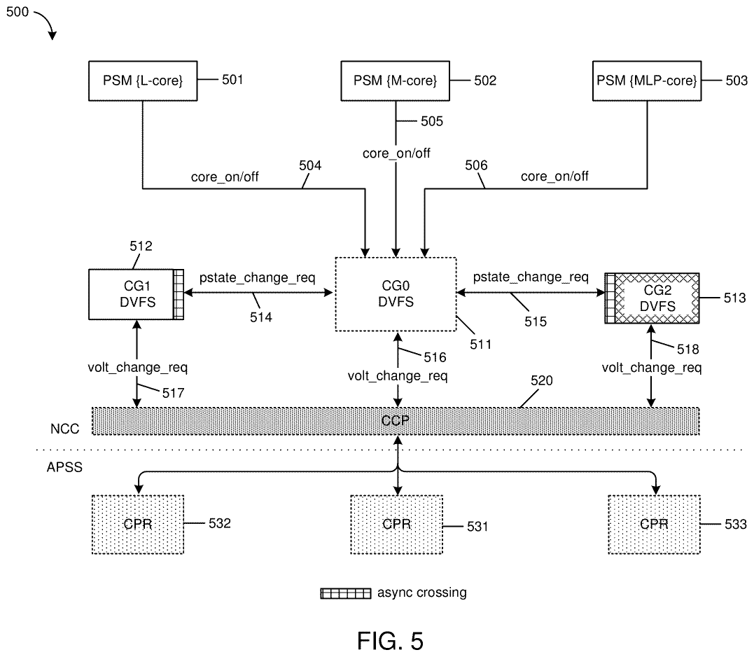

FIG. 5 illustrates an example cross core group dynamic voltage and frequency scaling (DVFS) architecture 500. In one example, the cross core group DVFS architecture 500 includes a first power state machine (PSM) 501, a second PSM 502, a third PSM 503, a first DVFS module 511, a second DVFS module 512 and a third DVFS module 513. In one example, the first PSM 501 sends a first bilevel (i.e., on or off) core power control signal 504 to the first DVFS module 511, the second PSM 502 sends a second bilevel core power control signal 505 to the first DVFS module 511 and the third PSM 503 sends a third bilevel core power control signal 506 to the first DVFS module 511.

In one example, the first bilevel core power control signal 504, the second bilevel core power control signal 505 and the third bilevel core power control signal 506 provide on/off control for a first plurality of processor cores, a second plurality of processor cores and a third plurality of processor cores, respectively. In one example, the first DVFS module 511 exchanges a first power state change request message 514 with the second DVFS module 512. In one example, the first DVFS module 511 exchanges a second power state change request message 515 with the third DVFS module 513. In one example, the first power state change request message 514 is used to modify a first power state of the second DVFS module. In one example, the second power state change request message 515 is used to modify a second power state related to the third DVFS module 513. In one example, the first power state change request message 514 and the second power state change request message 515 are timed asynchronously (i.e., independently) with respect to the timing of the second DVFS module 512 and the third DVFS module 513, hence the annotation “async crossing” in FIG. 5.

In one example, the first DVFS module 511 exchanges a first voltage change request message 516 with a central processing unit (CPU) control plane module (CCP) 520. In one example, the second DVFS module 512 exchanges a second voltage change request message 517 with the central processing unit (CPU) control plane module (CCP) 520. In one example, the third DVFS module 513 exchanges a third voltage change request message 518 with the central processing unit (CPU) control plane (CCP) module 520.

In one example, the CCP module 520 is coupled to a first core power reduction (CPR) module 531, to a second CPR module 532 and to a third CPR module 533. In one example, the first CPR module 531, the second CPR module 532 and the third CPR module 533 are part of a power management integrated circuit (PMIC) used for power management and control.

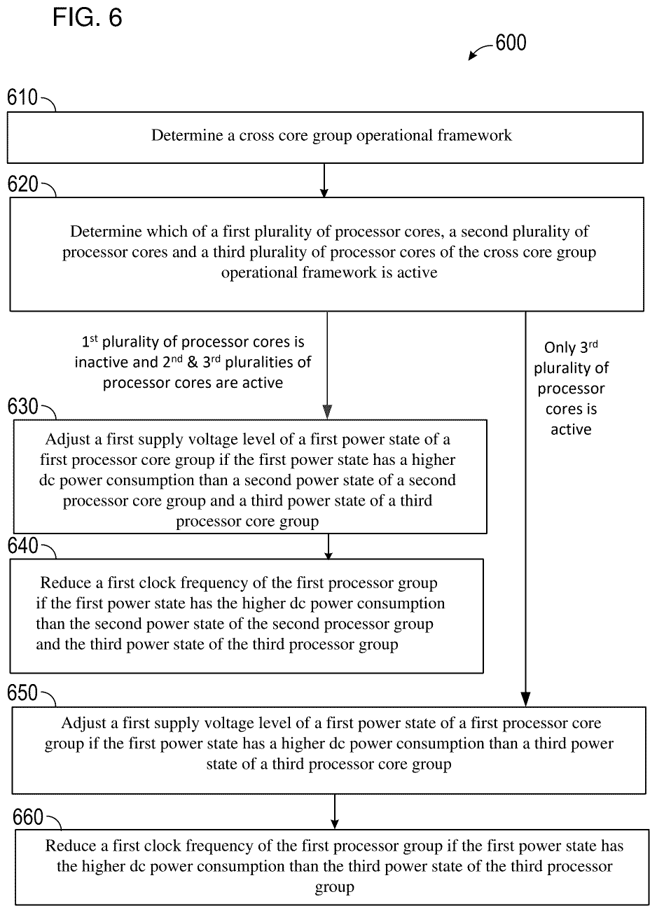

FIG. 6 illustrates an example flow diagram 600 for implementing dynamic voltage and frequency scaling (DVFS) capability. In block 610, determine a cross core group operational framework. In one example, a cross core group operational framework is determined. For example, the cross core group operational framework describes a multiprocessor operational configuration where a plurality of processor core groups are subject to dc power management. In one example, the cross core group operational framework is a first framework. The first framework includes a first plurality of processor cores in a first processor core group, wherein the first plurality of processor cores is active. Additionally, the first framework includes an auxiliary group (e.g., shared LLC module and a matrix multiplication module) controlled by a first power state machine (PSM) of the first processor core group. In one example, the first processor core group includes the first plurality of processor cores and the auxiliary group (e.g., shared LLC module and a matrix multiplication module). In one example, the first framework includes the first processor core group (the first plurality of processor cores and the auxiliary group) and the power state (i.e., active or inactive) of the first plurality of processor cores. In one example, the step of block 610 is performed by one of the following: a power state machine, a microcontroller, a microprocessor, a central processing unit (CPU), a processing engine, etc.

In one example, the first processor core group operates with a supply voltage and clock frequency higher than a second processor core group and higher than a third processor core group. The second processor core group includes a second plurality of processor cores. The third processor core group includes a third plurality of processor cores. In one example, a second framework includes the second processor core group and the power state (i.e., active or inactive) of the second plurality of processor cores. In one example, a third framework includes the third processor core group and the power state (i.e., active or inactive) of the third plurality of processor cores.

In one example, the first processor core group is optimized for performance. In one example, the second processor core group and the third processor core group are optimized for dc power efficiency. In one example, the determination of the cross core group operational framework is performed by the first power state machine of the first processor core group.

In one example, the cross core group operational framework is a second framework. The second framework includes the first plurality of processor cores, the second plurality of processor cores and third plurality of processor cores, wherein the first plurality of processor cores is inactive and wherein both the second and third pluralities of processor cores are active. In one example, the second framework includes the second processor core group and the third processor core group both controlled by a second power state machine of the second processor core group.

In one example, the cross core group operational framework is a third framework. The third framework includes the first plurality of processor cores, the second plurality of processor cores and third plurality of processor cores, wherein the first plurality of processor cores and the second plurality of processor cores are inactive and wherein the third plurality of processor cores is active. In one example, the third framework includes the third processor core group controlled by a third power state machine of the third processor core group.

In block 620, determine which of a first plurality of processor cores, a second plurality of processor cores and a third plurality of processor cores of the cross core group operational framework is active. In one example, the step of block 620 generates a determination for adjusting supply voltage and clock frequency. If the first plurality of processor cores is inactive (i.e., power collapsed) and if both the second plurality of processor cores and the third plurality of processor cores are active, then proceed to block 630 (and block 640). If only the third plurality of processor cores is active, then proceed to block 650 (and block 660). In one example, the step of block 620 is performed by one of the following: a power state machine, a microcontroller, a microprocessor, a central processing unit (CPU), a processing engine, etc.

In block 630, adjust a first supply voltage level of a first power state of a first processor core group if the first power state has a higher dc power consumption than a second power state of a second processor core group and a third power state of a third processor core group. In one example, a first supply voltage level of a first power state of a first processor core group is adjusted if the first power state has a higher dc power consumption than a second power state of a second processor core group and a third power state of a third processor core group.

In one example, there are three separate dedicated power state machines (i.e., logic circuits) for voltage control of each of the first plurality of processor cores 220, the second plurality of processor cores 230 and the third plurality of processor cores 240. In the stated example, an auxiliary group (with a shared LLC module and matrix multiplication module) also operates with the first power state; that is, the same power state machine (and voltage control) as the first plurality of processor cores. However, in one example, if the first plurality of processor cores is inactive, the auxiliary group will then be operating at a higher voltage than it needs. Thus, to implement power savings, a logical check is performed to ensure that the first power state has a higher voltage than the second and third power states. And, if the first power state is indeed higher, then the first power state is adjusted to a lower voltage. Otherwise, no adjustment is made.

In one example, the first supply voltage level adjustment is executed autonomously by the first power state machine (PSM). In one example, the first supply voltage level adjustment results in an adjusted first supply voltage level less than the first supply voltage level. In one example, the adjusted first supply voltage level results in improved power efficiency (i.e., lower dc power consumption) according to the following equation:

Pdc=k Vs²fc
where Pdc=dc power consumption, watts
k=device-dependent scaling factor, watts/volts² Hz
Vs=supply voltage, volts
fc=clock frequency, Hz.

In one example, the first supply voltage level adjustment is initiated upon receipt of a power state change request message from the second processor core group.

In one example, the power state change request message originates in the second power state machine. In one example, the power state change request message is sent to a first DVFS module of the first processor core group. In one example, the power state change request message is received asynchronously. In one example, a voltage change request message is sent to a CPU control plane (CCP) module from the first DVFS module to adjust the first supply voltage level. In one example, the CCP module is coupled to a core power reduction (CPR) module of a power management integrated circuit (PMIC). In one example, the step of block 630 is performed by one of the following: a power state machine, a dynamic voltage and frequency scaling (DVFS) module, a power supply, a post-regulator, a voltage regulator, a power source, etc.

In block 640, reduce a first clock frequency of the first processor core group if the first power state has the higher dc power consumption than the second power state of the second processor core group and the third power state of the third processor core group. In one example, a first clock frequency of the first processor core group is reduced if the first power state has the higher dc power consumption than the second power state of the second processor core group and the third power state of the third processor core group.

In one example, the first clock frequency reduction produces a reduced clock frequency. In one example, the first clock frequency reduction results in improved power efficiency (i.e., lower dc power consumption) according to the following equation:

Pdc=k Vs²fc
where Pdc=dc power consumption, watts
k=device-dependent scaling factor, watts/volts² Hz
Vs=supply voltage, volts
fc=clock frequency, Hz.

In one example, the first clock frequency reduction is executed autonomously by the first power state machine (PSM). In one example, the first clock frequency reduction is initiated upon receipt of the power state change request message from the second processor core group.

In one example, the power state change request message originates in the second power state machine. In one example, the power state change request message is sent to a first DVFS module of the first processor core group. In one example, the first clock frequency reduction and the adjusted first supply voltage level result in a proportional dc power consumption. In one example, the proportional dc power consumption is proportional to a product of the reduced clock frequency and a square of the adjusted first supply voltage level. In one example, the step of block 640 is performed by one of the following: a power state machine, a clock module, an oscillator, a frequency synthesizer, a phase lock loop, a direct digital synthesizer (DDS), etc.

In block 650, adjust a first supply voltage level of a first power state of a first processor core group if the first power state has a higher dc power consumption than a third power state of a third processor core group. In one example, a first supply voltage level of a first power state of a first processor core group is adjusted if the first power state has a higher dc power consumption than a third power state of a third processor core group.

In one example, the first supply voltage level adjustment is executed autonomously by the first power state machine (PSM). In one example, the first supply voltage level adjustment results in an adjusted first supply voltage level less than the first supply voltage level. In one example, the adjusted first supply voltage level results in improved power efficiency (i.e., lower dc power consumption) according to the following equation:

Pdc=k Vs²fc
where Pdc=dc power consumption, watts
k=device-dependent scaling factor, watts/volts² Hz
Vs=supply voltage, volts
fc=clock frequency, Hz.

In one example, the first supply voltage level adjustment is initiated upon receipt of a power state change request message from the third processor core group.

In one example, the power state change request message originates in the third power state machine. In one example, the power state change request message is sent to a first DVFS module of the first processor core group. In one example, the power state change request message is received asynchronously. In one example, a voltage change request message is sent to a CPU control plane (CCP) module from the first DVFS module to adjust the first supply voltage level. In one example, the CCP module is coupled to a core power reduction (CPR) module of a power management integrated circuit (PMIC). In one example, the step of block 650 is performed by one of the following: a power state machine, a dynamic voltage and frequency scaling (DVFS) module, a power supply, a post-regulator, a voltage regulator, a power source, etc.

In block 660, reduce a first clock frequency of the first processor core group if the first power state has the higher dc power consumption than the third power state of the third processor core group. In one example, a first clock frequency of the first processor core group is reduced if the first power state has the higher dc power consumption than the third power state of the third processor core group.

In one example, the first clock frequency reduction is executed autonomously by the first power state machine (PSM). In one example, the first clock frequency reduction results in improved power efficiency (i.e., lower dc power consumption) according to the following equation:

Pdc=k Vs²fc
where Pdc=dc power consumption, watts
k=device-dependent scaling factor, watts/volts² Hz
Vs=supply voltage, volts
fc=clock frequency, Hz.

In one example, the first clock frequency reduction is initiated upon receipt of the power state change request message from the third processor core group.

In one example, the power state change request message originates in the third power state machine. In one example, the power state change request message is sent to a first DVFS module of the first processor core group. In one example, the first clock frequency reduction and the adjusted first supply voltage level result in a proportional de power consumption. In one example, the proportional de power consumption is proportional to a product of the reduced clock frequency and a square of the adjusted first supply voltage level. In one example, the step of block 660 is performed by one of the following: a power state machine, a clock module, an oscillator, a frequency synthesizer, a phase lock loop, a direct digital synthesizer (DDS), etc.

In one example, the auxiliary group includes a last level cache (LLC) memory shared among the first plurality of processor cores, the second plurality of processor cores and the third plurality of processor cores. In one example, the auxiliary group further includes a matrix multiplication module configured to perform matrix multiplication for any of the first plurality of processor cores, the second plurality of processor cores or the third plurality of processor cores. In one example, the first DVFS module is further configured to reduce the first supply voltage to generate a reduced supply voltage and to reduce the first clock frequency to generate a reduced clock frequency. In one example, the first DVFS module is further configured to supply the reduced supply voltage and the reduced clock frequency to the auxiliary group.

In one example, the determination is that the first plurality of processor cores is inactive, the second plurality of processor cores is active and the third plurality of processor cores is active, or the determination is that the third plurality of processor cores is active, the first plurality of processor cores is inactive and the second plurality of processor cores is inactive. In one example, the apparatus further includes means for determining that a first power state of the first processor core group has a higher de power consumption than a second power state of the second processor core group and a third power state of the third processor core group, or that the first power state of the first processor core group has a higher dc power consumption than a third power state of the third processor core group. In one example, the apparatus further includes means for reducing the first supply voltage level. In one example, the apparatus further includes means for reducing the first clock frequency.

In one example, a first processor core group includes the first plurality of processor cores and an auxiliary group, wherein a second processor core group includes the second plurality of processor cores, and wherein a third processor core group includes the third plurality of processor cores.

In one example, the determination is that the first plurality of processor cores is inactive, the second plurality of processor cores is active and the third plurality of processor cores is active. In one example, the method further includes determining that a first power state of the first processor core group has a higher dc power consumption than a second power state of the second processor core group and a third power state of the third processor core group. In one example, the method further includes reducing the first supply voltage level. In one example, the method further includes reducing the first clock frequency.

In one example, the determination is that the third plurality of processor cores is active, the first plurality of processor cores is inactive and the second plurality of processor cores is inactive. In one example, the method further includes determining that the first power state of the first processor core group has a higher dc power consumption than a third power state of the third processor core group. In one example, the method further includes reducing the first supply voltage level. In one example, the method further includes reducing the first clock frequency.

In one aspect, one or more of the steps for providing dynamic voltage and frequency scaling (DVFS) capability in FIG. 6 may be executed by one or more processors which may include hardware, software, firmware, etc. The one or more processors, for example, may be used to execute software or firmware needed to perform the steps in the flow diagram of FIG. 6. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
a first processor core group, wherein the first processor core group includes a first plurality of processor cores, a first power state machine and an auxiliary group;
a second processor core group coupled to the first processor group, wherein the second processor core group includes a second plurality of processor cores;
a third processor core group coupled to the second processor group, wherein the third processor core group includes a third plurality of processor cores, wherein the first power state machine is configured to determine which of the first plurality of processor cores, the second plurality of processor cores and the third plurality of processor cores is active to generate a determination; and
a first dynamic voltage and frequency scaling (DVFS) module, coupled to the first power state machine, the first DVFS module configured to adjust a first supply voltage and a first clock frequency of the first processor core group based on the determination.

2. The apparatus of claim 1, wherein the auxiliary group includes a last level cache (LLC) memory shared among the first plurality of processor cores, the second plurality of processor cores and the third plurality of processor cores.

3. The apparatus of claim 2, wherein the auxiliary group further includes a matrix multiplication module configured to perform matrix multiplication for any of the first plurality of processor cores, the second plurality of processor cores or the third plurality of processor cores.

4. The apparatus of claim 3, wherein the first DVFS module is further configured to reduce the first supply voltage to generate a reduced supply voltage and to reduce the first clock frequency to generate a reduced clock frequency.

5. The apparatus of claim 4, wherein the first DVFS module is further configured to supply the reduced supply voltage and the reduced clock frequency to the auxiliary group.

6. An apparatus comprising:
means for determining a cross core group operational framework;
means for determining which of a first plurality of processor cores, a second plurality of processor cores and a third plurality of processor cores of the cross core group operational framework is active to generate a determination; and
means for adjusting a first supply voltage and a first clock frequency depending on the determination.

7. The apparatus of claim 6, wherein the determination is that the first plurality of processor cores is inactive, the second plurality of processor cores is active and the third plurality of processor cores is active, or wherein the determination is that the third plurality of processor cores is active, the first plurality of processor cores is inactive and the second plurality of processor cores is inactive.

8. The apparatus of claim 7, further comprising means for determining that a first power state of the first processor core group has a higher dc power consumption than a second power state of the second processor core group and a third power state of the third processor core group, or that the first power state of the first processor core group has a higher dc power consumption than a third power state of the third processor core group.

9. The apparatus of claim 8, further comprising means for reducing the first supply voltage level.

10. The apparatus of claim 8, further comprising means for reducing the first clock frequency.

11. A method comprising:
determining a cross core group operational framework;
determining which of a first plurality of processor cores, a second plurality of processor cores and a third plurality of processor cores of the cross core group operational framework is active to generate a determination; and
adjusting a first supply voltage and a first clock frequency depending on the determination.

12. The method of claim 11, wherein a first processor core group includes the first plurality of processor cores and an auxiliary group, wherein a second processor core group includes the second plurality of processor cores, and wherein a third processor core group includes the third plurality of processor cores.

13. The method of claim 12, wherein the determination is that the first plurality of processor cores is inactive, the second plurality of processor cores is active and the third plurality of processor cores is active.

14. The method of claim 13, further comprising determining that a first power state of the first processor core group has a higher dc power consumption than a second power state of the second processor core group and a third power state of the third processor core group.

15. The method of claim 14, further comprising reducing the first supply voltage level.

16. The method of claim 15, further comprising reducing the first clock frequency.

17. The method of claim 12, wherein the determination is that the third plurality of processor cores is active, the first plurality of processor cores is inactive and the second plurality of processor cores is inactive.

18. The method of claim 17, further comprising determining that the first power state of the first processor core group has a higher dc power consumption than a third power state of the third processor core group.

19. The method of claim 18, further comprising reducing the first supply voltage level.

20. The method of claim 19, further comprising reducing the first clock frequency.
